(19) United States
(12) Patent Application Publication
(10) Pub. No.: US 2026/0328934 A1
(43) Pub. Date: Oct. 22, 2026

(54) RADIO WAVE SENSOR AND OBJECT DETECTION METHOD

(71) Applicant: Sumitomo Electric Industries, Ltd., Osaka-shi, Osaka (JP)

(72) Inventors: Nobuo HIGASHIDA, Osaka-shi, Osaka (JP); Shigeki UMEHARA, Osaka-shi, Osaka (JP); Ryota MORINAKA, Osaka-shi, Osaka (JP); Hiroki KATO, Osaka-shi, Osaka (JP)

(73) Assignee: Sumitomo Electric Industries, Ltd., Osaka-shi, Osaka (JP)

(21) Appl. No.: 19/107,556

(22) PCT Filed: Jun. 8, 2023
(86) PCT No.: PCT/JP2023/021318

§ 371 Date: Feb. 27, 2025

(30) Foreign Application Priority Data
Aug. 29, 2022 (JP) 2022-136196

(51) Int. Cl. G01S 13/92; G01S 13/42; G01S 13/58

(52) U.S. Cl. CPC G01S 13/92; G01S 13/42; G01S 13/584

(57) ABSTRACT

A radio wave sensor has a transmission antenna, a reception antenna that receives reflected waves resulting from radio waves reflected by an object, a detection unit that analyzes the reflected waves and detects the object, and a reflecting plate that reflects radio waves, the transmission antenna transmitting first radio waves to a first area, the reception antenna receiving first reflected waves resulting from the first radio waves being reflected by a first object in the first area, the transmission antenna furthermore transmitting second radio waves to the reflecting plate, the reflecting plate reflecting the second radio waves to a second area different from the first area, and the reflecting plate also reflecting, to the reception antenna, second reflected waves that result from the second radio waves being reflected by a second object in the second area, and the reception antenna receiving the second reflected waves reflected by the reflecting plate.

### TECHNICAL FIELD

The present disclosure relates to a radio wave sensor and an object detection method.

The present application claims priority under Japanese Patent Application No. 2022-136196 filed on Aug. 29, 2022, the entire contents of which are hereby incorporated by reference herein.

### BACKGROUND ART

Radio wave sensors for traffic monitoring detect objects (vehicles, pedestrians, etc.) in detection areas set on the road. Radio wave sensors are installed at high locations, such as near the top of the pillar, but the areas directly beneath the radio wave sensors are likely to become blind spots. Due to the constraints on the installation locations of the radio wave sensors, it may be required to include areas directly beneath the radio wave sensors in their detection areas.

PTL 1 discloses a radio wave sensor including: a transmission unit configured to be capable of transmitting a radio wave from a first antenna to a first area, with an irradiation range limited to the first area, which is an area at the beginning of a pedestrian crossing and does not include entirety of the pedestrian crossing; a reception unit configured to receive the radio wave from the first area; and a detection unit configured to detect a target object within the first area based on the radio wave received by the reception unit. In the radio wave sensor disclosed in PTL 1, the transmission unit is further configured to be capable of transmitting a radio wave from a second antenna to a second area, with an irradiation range limited to the second area, which is an area of the pedestrian crossing including a portion distant from the radio wave sensor than the first area; the reception unit is further configured to receive the radio wave from the second area; and the detection unit is further configured to detect a target object within the second area based on the radio wave from the second area received by the reception unit.

### CITATION LIST

### Patent Literature

PTL 1: Japanese Unexamined Patent Application Publication No. 2015-148578

### SUMMARY OF INVENTION

A radio wave sensor according to an aspect of the present disclosure includes: at least one transmission antenna configured to transmit a radio wave; a reception antenna configured to receive a reflected wave, which is a radio wave transmitted from the transmission antenna and reflected by an object; a detection unit configured to analyze the reflected wave received by the reception antenna and detect the object; and a reflector configured to reflect a radio wave. The transmission antenna transmits a first radio wave to a first area; the reception antenna receives a first reflected wave, which is the first radio wave reflected by a first object within the first area; the transmission antenna further transmits a second radio wave to the reflector; the reflector reflects the second radio wave to a second area different from the first area, and the reflector further reflects a second reflected wave, which is the second radio wave reflected by a second object within the second area, to the reception antenna; and the reception antenna receives the second reflected wave reflected by the reflector.

An object detection method according to an aspect of the present invention includes: transmitting a first radio wave from at least one transmission antenna to a first area, and transmitting a second radio wave to a reflector; receiving, by a reception antenna, a first reflected wave, which is the first radio wave reflected by a first object within the first area; reflecting, by the reflector, the second radio wave to a second area different from the first area, and reflecting, by the reflector, a second reflected wave reflected from a second object within the second area to the reception antenna; receiving, by the reception antenna, the second reflected wave reflected by the reflector; and analyzing the first reflected wave and the second reflected wave received by the reception antenna, and detecting the first object and the second object.

### BRIEF DESCRIPTION OF DRAWINGS

FIG. 1 is a diagram illustrating an example of the use of a radio wave sensor according to an embodiment.

FIG. 2 is a perspective view illustrating an example of the appearance of the radio wave sensor according to the embodiment.

FIG. 3A is a diagram for describing an example of the radio wave irradiation range of a radio wave sensor provided with no reflector.

FIG. 3B is a diagram for describing an example of the radio wave irradiation range of the radio wave sensor according to the embodiment.

FIG. 4 is a block diagram illustrating an example of the internal configuration of the radio wave sensor according to the embodiment.

FIG. 5 is a functional block diagram illustrating an example of the functions of the radio wave sensor according to the embodiment.

FIG. 6 is a diagram for describing the principle of azimuth angle detection.

FIG. 7 is a plan view of the radio wave sensor for describing an example of the horizontal angle of a radio wave incident on a reflector and the horizontal angle of a radio wave reflected by the reflector.

FIG. 8 is a side view of the radio wave sensor for describing an example of the angle of a radio wave incident on the reflector and the angle of a radio wave reflected by the reflector.

FIG. 9 is a diagram for describing detection of the depression/elevation angle of a reflected wave received via the reflector.

FIG. 10 is a flowchart illustrating an example of an object detection process.

FIG. 11 is a flowchart illustrating an example of a reflected wave determination process.

FIG. 12 is a perspective view illustrating a first modification of the configuration of the radio wave sensor according to the embodiment.

FIG. 13 is a side view illustrating a second modification of the configuration of the radio wave sensor according to the embodiment.

FIG. 14 is a perspective view illustrating a third modification of the radio wave sensor according to the embodiment.

### DETAILED DESCRIPTION

### Problems to be Solved by Present Disclosure

In the apparatus disclosed in PTL 1, it is necessary to provide the second antenna separately from the first antenna in order to expand the detection area.

According to the present disclosure, the detection area of a radio wave sensor can be expanded without involving an increase in the number of transmission antennas.

### Overview of Embodiment of Present Disclosure

An overview of an embodiment of the present disclosure will be listed and set forth below.
(1) A radio wave sensor according to the present embodiment includes: at least one transmission antenna configured to transmit a radio wave; a reception antenna configured to receive a reflected wave, which is a radio wave transmitted from the transmission antenna and reflected by an object; a detection unit configured to analyze the reflected wave received by the reception antenna and detect the object; and a reflector configured to reflect a radio wave. The transmission antenna transmits a first radio wave to a first area; the reception antenna receives a first reflected wave, which is the first radio wave reflected by a first object within the first area; the transmission antenna further transmits a second radio wave to the reflector; the reflector reflects the second radio wave to a second area different from the first area, and the reflector further reflects a second reflected wave, which is the second radio wave reflected by a second object within the second area, to the reception antenna; and the reception antenna receives the second reflected wave reflected by the reflector. This makes it possible to expand the detection area of the radio wave sensor without involving an increase in the number of transmission antennas.
(2) In (1) mentioned above, the radio wave sensor is such that a normal direction of a reflective surface of the reflector and an arrangement direction of a plurality of the reception antennas may be perpendicular to each other, and the detection unit may detect an angle of the second object present within the second area relative to the radio wave sensor based on a phase difference of the second reflected wave received by the plurality of reception antennas. This makes it possible to detect not only the presence of the second object, but also its angle.
(3) In (2) mentioned above, the reflector may include a first reflective surface and a second reflective surface that are not parallel to each other; a first normal direction of the first reflective surface and the arrangement direction of the plurality of reception antennas may be perpendicular to each other; and a second normal direction of the second reflective surface and the arrangement direction of the plurality of reception antennas may be perpendicular to each other. This makes it possible to accurately detect the azimuth angle of the second object even when the reflector includes reflective surfaces that are not parallel to each other.
(4) In any one of (1) to (3) mentioned above, the radio wave sensor may include a determination unit configured to determine whether a reflected wave received by the plurality of reception antennas is the first reflected wave or the second reflected wave based on a phase difference of the second reflected wave received by the plurality of reception antennas. This makes it possible to identify a reflected wave directly received from an object and a reflected wave received via the reflector.
(5) In (4) mentioned above, the radio wave sensor is such that the plurality of reception antennas may include a plurality of the reception antennas in a perpendicular direction, which are arranged in a direction perpendicular to a horizontal direction; and the determination unit may determine whether a reflected wave received by the reception antennas is the first reflected wave or the second reflected wave based on a phase difference of the second reflected wave received by the plurality of reception antennas in the perpendicular direction. This makes it possible to identify a reflected wave directly received from an object and a reflected wave received via the reflector by using the plurality of reception antennas.
(6) In (4) mentioned above, the transmission antenna may include a first transmission antenna and a second transmission antenna arranged in a direction perpendicular to a horizontal direction; the plurality of reception antennas may receive a reflected wave which is a radio wave transmitted from the first transmission antenna and reflected by an object, and a reflected wave which is a radio wave transmitted from the second transmission antenna and reflected by the object; and the determination unit may determine whether a reflected wave received by the plurality of reception antennas is the first reflected wave or the second reflected wave based on a phase difference of a reflected wave which is a radio wave transmitted from the first transmission antenna and reflected by an object and a reflected wave which is a radio wave transmitted from the second transmission antenna and reflected by the object. This makes it possible to identify a reflected wave directly received from an object and a reflected wave received via the reflector by using the first transmission antenna and the second transmission antenna.
(7) An object detection method according to the present embodiment includes: transmitting a first radio wave from at least one transmission antenna to a first area, and transmitting a second radio wave to a reflector; receiving, by a reception antenna, a first reflected wave, which is the first radio wave reflected by a first object within the first area; reflecting, by the reflector, the second radio wave to a second area different from the first area, and reflecting, by the reflector, a second reflected wave reflected from a second object within the second area to the reception antenna; receiving, by the reception antenna, the second reflected wave reflected by the reflector; and analyzing the first reflected wave and the second reflected wave received by the reception antenna, and detecting the first object and the second object. This makes it possible to expand the detection area of the radio wave sensor without involving an increase in the number of transmission antennas.

The present disclosure can be implemented not only as a radio wave sensor with a characteristic configuration as mentioned above, or an object detection method for executing characteristic steps, but also as a computer program for causing a computer to perform the characteristic steps mentioned above. Furthermore, the present disclosure can be implemented as a system including the radio wave sensor, or a portion of the radio wave sensor can be implemented as a semiconductor integrated circuit.

### Details of Embodiment of Present Disclosure

Hereinafter, an embodiment of the present disclosure will be described in detail with reference to the drawings. Note that at least some portions of the embodiment described below may be optionally combined.

### [1. Configuration of Radio Wave Sensor]

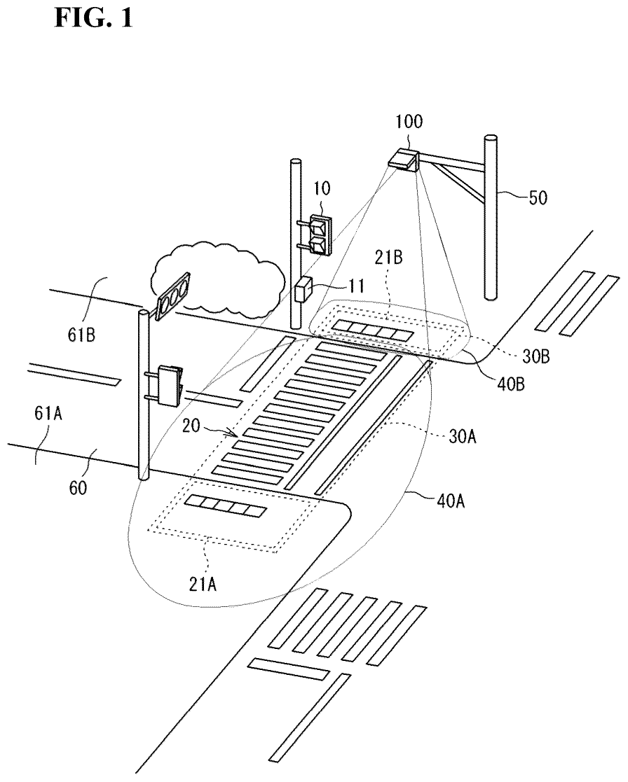

FIG. 1 is a diagram illustrating an example of the use of a radio wave sensor according to an embodiment. A radio wave sensor 100 according to the embodiment is a radio wave radar for traffic monitoring, and it detects pedestrians on a pedestrian crossing 20. The radio wave sensor 100 is, for example, a millimeter wave radar.

The radio wave sensor 100 is an infrastructure radio wave sensor attached to a structure 50 provided on the road. The structure 50 has a height of several meters, and the radio wave sensor 100 is installed at a height of several meters above the ground.

The radio wave sensor 100 detects objects (such as pedestrians, bicycles, and vehicles) on the pedestrian crossing 20 by irradiating the pedestrian crossing 20 with a radio wave (millimeter wave) and receiving a reflected wave thereof. More specifically, the radio wave sensor 100 can detect a distance from the radio wave sensor 100 to an object on the pedestrian crossing 20, a velocity of the object, and a horizontal angle (hereinafter referred to as “azimuth angle”) at a position where the object is present relative to the axis of radio wave irradiation.

The radio wave sensor 100 can further detect a vertical angle (hereinafter may also be referred to as “depression angle”) at a position where the object is present.

Here, those crossing the pedestrian crossing 20 and those waiting to cross due to the traffic signal are referred to as “pedestrians.” Pedestrians include walkers and cyclists. The radio wave sensor 100 detects pedestrians and detects their position (distance and azimuth angle) as well as their velocity.

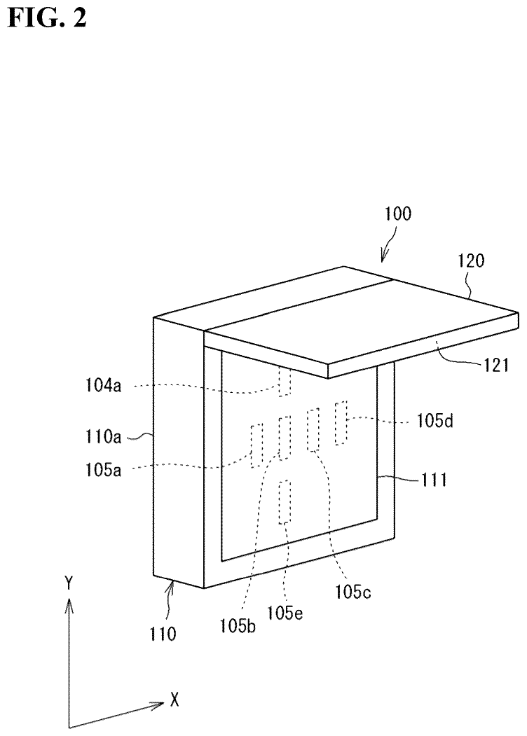

FIG. 2 is a perspective view illustrating an example of the appearance of the radio wave sensor according to the embodiment. The radio wave sensor 100 includes a body 110 and a reflector 120.

The body 110 includes, for example, a rectangular housing 110a, and a transmission antenna 104a and reception antennas 105a, 105b, 105c, 105d, and 105e, which are housed in the housing 110a.

One side of the housing 110a includes a radio wave transmission/reception surface 111. The transmission antenna 104a emits (transmits) a radio wave via the transmission/reception surface 111, and the reception antenna 105a, 105b, 105c, 105d, and 105e receive a radio wave via the transmission/reception surface 111. Here, the horizontal direction along the transmission/reception surface 111 is referred to as the “X direction”, and the direction that intersects the X direction at right angles and is along the transmission/reception surface 111 is referred to as the “Y direction”.

The reflector 120 is attached to the upper edge of the transmission/reception surface 111 of the housing 110a. One side of the reflector 120 is a mirror surface and is a reflective surface 121 that reflects a radio wave. The reflective surface 121 of the reflector 120 is positioned to reflect a portion of a radio wave transmitted from the transmission/reception surface 111. The reflective surface 121 of the reflector 120 reflects the radio wave toward the road below. For example, the reflective surface 121 is directed downward.

Referring back to FIG. 1, the radio wave sensor 100 has detection areas 30A and 30B, which are the set ranges on the road for detecting objects. The detection areas 30A and 30B are respectively set as a portion of radio wave irradiation areas 40A and 40B of the radio wave sensor 100.

The radio wave irradiation area 40A is the range directly irradiated with a radio wave from the transmission/reception surface 111 of the radio wave sensor 100. The radio wave irradiation area 40B is the range irradiated with, of a radio wave transmitted from the transmission/reception surface 111 of the radio wave sensor 100, a portion reflected by the reflector 120.

The detection area 30A is set within the radio wave irradiation area 40A, and the detection area 30B is set within the radio wave irradiation area 40B. The detection area 30A is an example of a first area, and the detection area 30B is an example of a second area.

Standby areas 21A and 21B for pedestrians are provided at both ends of the pedestrian crossing 20. The standby areas 21A and 21B are set in sidewalks 61A and 61B located on both sides of a road 60. In the standby areas 21A and 21B, pedestrians wait for a pedestrian traffic light 10 to switch from red (passage prohibited) to green (passage permitted).

The structure 50, to which the radio wave sensor 100 is attached, is installed, for example, on the sidewalk 61B, which is one of the sidewalks 61A and 61B located on both sides of the road 60. Hereinafter, the standby area 21A provided on the sidewalk 61A where the radio wave sensor 100 is not installed is referred to as the “first standby area 21A”, and the standby area 21B provided on the sidewalk 61B where the radio wave sensor 100 is installed is referred to as the “second standby area 21B”.

The detection area 30A is an area that includes the pedestrian crossing 20 and the first standby area 21A. The detection area 30B is an area that includes the second standby area 21B. That is, the radio wave irradiation area 40B is set to a position closer to the radio wave sensor 100 than the radio wave irradiation area 40A.

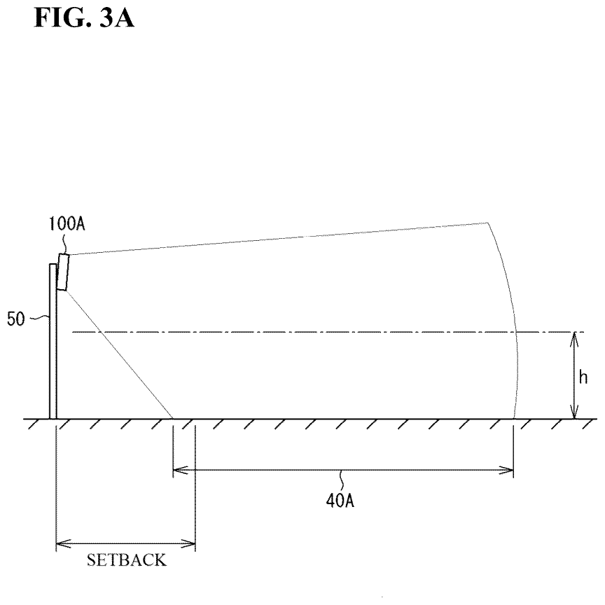

FIG. 3A is a diagram illustrating an example of the radio wave irradiation range of a radio wave sensor 100A not provided with the reflector 120. As illustrated in FIG. 3A, a radio wave is emitted radially from the transmission/reception surface 111 of the radio wave sensor 100A. The radio wave sensor 100A is adjusted in its installation angle so that the axis of radio wave irradiation (e.g., an axis passing through the center of the transmission/reception surface 111 and perpendicular to the transmission/reception surface 111), which has high directivity in the Y direction, is oriented toward the first standby area 21A. From the radio wave sensor 100A installed in this way, a portion of the radio wave is emitted diagonally upward from the transmission/reception surface 111.

The height of a to-be-detected pedestrian (or vehicle) on the pedestrian crossing 20 is within a range of h or less from the ground. Thus, it is only necessary for the radio wave sensor 100A to be able to detect an object at a height of h or less. That is, a radio wave emitted above the height h is not used for object detection.

The second standby area 21B is set with a width of 2 m or more, extending in the direction toward the radio wave sensor 100A (structure 50) from the boundary between the pedestrian crossing 20 and the sidewalk 61B (see FIG. 1). Here, the distance from the edge of the pedestrian crossing 20 on the sidewalk 61B side (the boundary between the pedestrian crossing 20 and the sidewalk 61B) to the installation position of structure 50 is referred to as the “setback”. The setback must be greater than the width of the second standby area 21B. That is, in order to set the second standby area 21B with a width of 2 m, the setback must be greater than 2 m.

If the setback is small, a sufficiently intense radio wave can be emitted to the first standby area 21A, which is separated from the radio wave sensor 100A, ensuring sufficient detection accuracy in the first standby area 21A. On the other hand, there is a possibility that no radio wave is emitted to the second standby area 21B, which is proximate to the radio wave sensor 100A. If the setback is large, a radio wave can be emitted to the second standby area 21B, but the intensity of a radio wave emitted to the first standby area 21A may decrease, which could lead to a reduction in detection accuracy in the first standby area 21A. Furthermore, if the setback is large, it may be impossible to install the structure 50 due to buildings or the like.

FIG. 3B is a diagram for describing an example of the radio wave irradiation range of the radio wave sensor according to the embodiment.

The transmission antenna 104a transmits a radio wave (first radio wave) toward the detection area 30A. The reception antennas 105a, 105b, 105c, 105d, and 105e receive a reflected wave (first reflected wave), which is the radio wave reflected by an object (first object) within the detection area 30A. Hereinafter, a reflected wave reflected by an object within the detection area 30A and directly received (not via the reflector 120) by the reception antennas 105a, 105b, 105c, 105d, and 105e will also be referred to as “a direct reflected wave”.

The transmission antenna 104a transmits a radio wave (second radio wave) toward the reflector 120. The radio wave transmitted toward the reflector 120 is reflected by the reflector 120 to the detection area 30B. The reception antennas 105a, 105b, 105c, 105d, and 105e receive, via the reflector 120, a portion of a reflected wave (second reflected wave), which is the radio wave reflected by an object (second object) within the detection area 30B. Hereinafter, a reflected wave which is a radio wave reflected by an object within the detection area 30B and received by the reception antennas 105a, 105b, 105c, 105d, and 105e via the reflector 120 will also be referred to as “an indirect reflected wave”.

The description will be given using FIG. 3B. In the present embodiment, a portion of a radio wave emitted upward from the transmission/reception surface 111 is reflected by the reflector 120 and directed toward the ground. As mentioned earlier, a radio wave emitted upward is unnecessary. Thus, even if the reflector 120 is provided, a radio wave can be emitted within a range of h or less from the ground.

The irradiation area 40B of a radio wave reflected by the reflector 120 is closer to the radio wave sensor 100 than the radio wave irradiation area 40A. Thus, even if the setback is small, a radio wave can be emitted to the second standby area 21B.

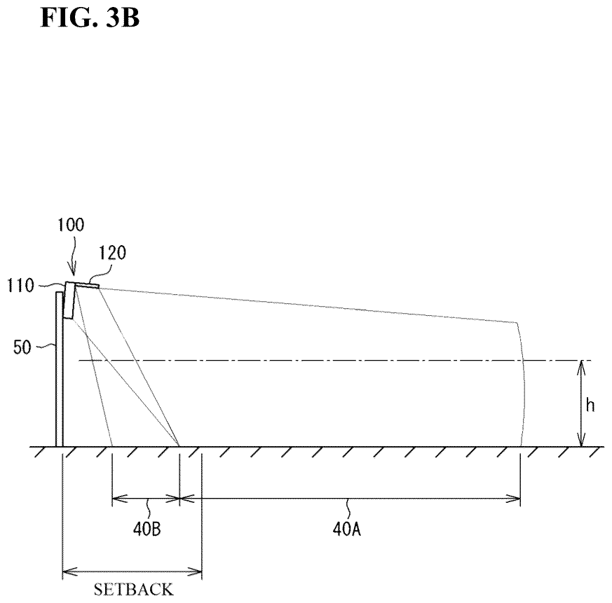

FIG. 4 is a block diagram illustrating an example of the internal configuration of the radio wave sensor according to the embodiment. The radio wave sensor 100 includes a processor 101, a non-volatile memory 102, a volatile memory 103, a transmission circuit 104, a reception circuit 105, and a communication interface (communication I/F) 106.

The volatile memory 103 is a semiconductor memory such as, for example, SRAM (Static Random Access Memory), DRAM (Dynamic Random Access Memory), etc. The non-volatile memory 102 is, for example, flash memory, hard disk, or ROM (Read Only Memory). The non-volatile memory 102 stores an analysis program 107, which is a computer program, and data used for executing the analysis program 107. Each function of the radio wave sensor 100 is implemented by the processor 101 executing the analysis program 107. The analysis program 107 can be stored on a recording medium such as flash memory, ROM, CD-ROM, etc. Using the analysis program 107, the processor 101 can detect objects within the detection areas 30A and 30B.

The processor 101 is, for example, a CPU (Central Processing Unit). Note that the processor 101 is not limited to a CPU. The processor 101 may be a GPU (Graphics Processing Unit). The processor 101 may be, for example, an ASIC (Application Specific Integrated Circuit) or a programmable logic device such as a gate array, an FPGA (Field Programmable Gate Array), etc. In this case, the ASIC or the programmable logic device is configured to be capable of executing processing that is the same as or similar to the analysis program 107.

The transmission circuit 104 includes the transmission antenna 104a. Note that the number of transmission antennas 104a is not limited to one, and may be plural. The transmission circuit 104 generates a modulated wave and transmits the generated modulated wave from the transmission antenna 104a. The transmitted modulated wave reflects off an object (e.g., a pedestrian or a vehicle).

The reception circuit 105 includes the reception antennas 105a, 105b, 105c, 105d, and 105e. The reception circuit 105 performs signal processing on the received reflected wave. Reflected wave data generated by the signal processing is provided to the processor 101. The processor 101 analyzes the reflected wave data and detects an object's position (distance and azimuth angle) as well as its velocity.

Referring back to FIG. 2, the reception antennas 105a, 105b, 105c, and 105d are arranged in a row in the X direction (horizontal direction). By using the multiple reception antennas 105a, 105b, 105c, and 105d arranged in the horizontal direction, the azimuth angle of an object can be detected.

The reception antennas 105b and 105e are arranged in a row in the Y direction (perpendicular to the horizontal direction). By using the multiple reception antennas 105b and 105e arranged in the Y direction, the angle (depression angle) of a straight line from the transmission/reception surface 111 to an object relative to the horizontal plane can be detected.

Referring back to FIG. 4, the communication I/F 106 is used for communication with an external apparatus. The communication I/F 106 is connected to, for example, a server at a traffic control center, and is able to communicate with the server. The communication I/F 106 can communicate with an external apparatus (e.g., a laptop computer or a tablet used by the installation worker of the radio wave sensor 100), for example, via a communication cable or by wireless communication.

### [2. Functions of Radio Wave Sensor]

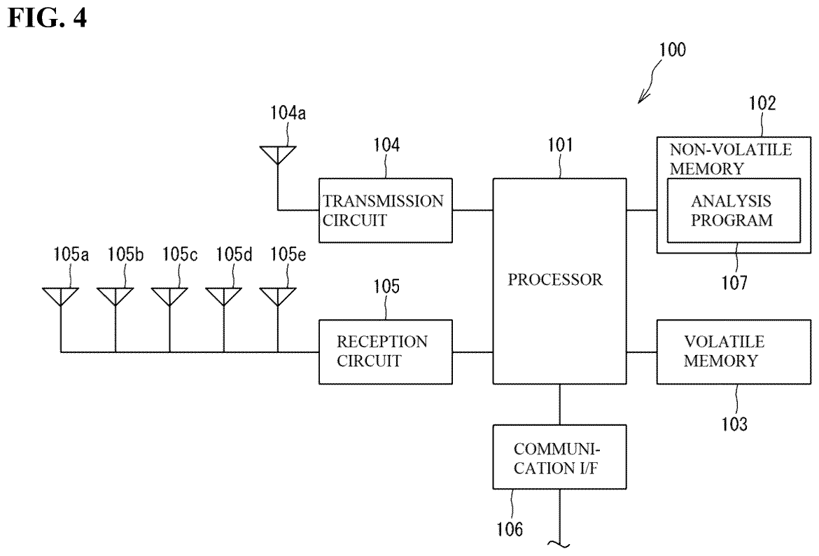

FIG. 5 is a functional block diagram illustrating an example of the functions of the radio wave sensor 100 according to the embodiment. By the processor 101 executing the analysis program 107, the functions of an object detection unit 131 and a determination unit 132 are implemented.

The object detection unit 131 detects an object based on a reflected wave which is a radio wave emitted toward the object and reflected back from the object. The object detection unit 131 is an example of a detection unit. The object detection unit 131 detects an object within the detection area 30A by analyzing a direct reflected wave, and detects an object within the detection area 30B by analyzing an indirect reflected wave.

The transmission circuit 104 transmits a transmission signal, which is a modulated wave, from the transmission antenna 104a. The transmission signal from the transmission antenna 104a reflects off an object. The reception antennas 105a, 105b, 105c, 105d, and 105e receive the reflected wave from the object. The object detection unit 131 combines a modulated wave signal output from the transmission circuit 104 with a reflected wave signal output from the reception circuit 105 to generate an intermediate frequency signal (hereinafter referred to as an “IF signal”). The object detection unit 131 applies a fast Fourier transform (FFT) to the IF signal to obtain distance, velocity, and azimuth angle information.

The reflection intensity of a radio wave varies depending on the object's surface shape, material, and the like. Because the angle and material of the object's surface differ by part of the surface, the reflection intensity of a radio wave varies from part to part. That is, a reflected wave from a single object includes multiple peaks (hereinafter referred to as “reflection points”). The object detection unit 131 groups together multiple reflection points from a single object within the waveform of the reflected wave and determines a representative value for the reflection points belonging to the same group. One example of a representative value is the center of gravity, while other examples include the median or the mean. The object detection unit 131 assigns the representative value of the group to the single object.

Detection of the azimuth angle of an object will be described. The object detection unit 131 detects the azimuth angle of an object based on the phase difference of a reflected wave received by the multiple reception antennas 105a, 105b, 105c, and 105d. More specifically, the object detection unit 131 detects an azimuth angle at which an object within the detection area 30A is present based on the phase difference of a direct reflected wave received by the reception antennas 105a, 105b, 105c, and 105d.

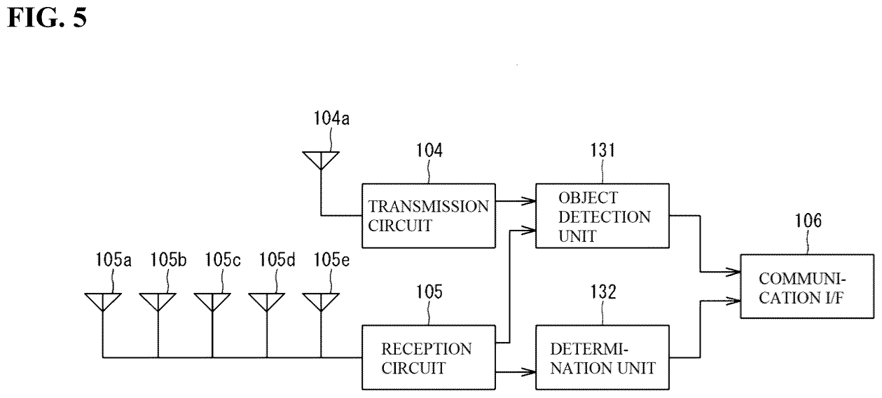

FIG. 6 a diagram for describing the principle of azimuth angle detection. Let θ be the horizontal angle of a to-be-detected object T relative to the axis of radio wave irradiation, D be the distance between two adjacent reception antennas 105a and 105b, and λ be the wavelength of the radio wave.

The reception antenna 105b is further distant from the to-be-detected object T than the reception antenna 105a by D sin θ. Note that the distances from the reception antennas 105a and 105b to the to-be-detected object T are sufficiently longer than distance D between the reception antennas 105a and 105b.

In this case, the phase difference ΔΦ of the reflected wave received between the reception antennas 105a and 105b is expressed by equation (1) below:

$$[ Eq . 1 ]$$

$$ΔΦ = \frac{2 π D sin θ}{λ} \qquad ( 1 )$$

Thus, the horizontal angle (azimuth angle) θ is expressed by equation (2) below:

$$[ Eq . 2 ]$$

$$θ = {sin}^{- 1} \frac{λΔΦ}{2 π D} \qquad ( 2 )$$

Next, detection of the azimuth angle in the case where a radio wave is reflected by the reflector 120 will be described. The object detection unit 131 detects an azimuth angle at which an object within the detection area 30B is present based on the phase difference of an indirect reflected wave received by the reception antennas 105a, 105b, 105c, and 105d.

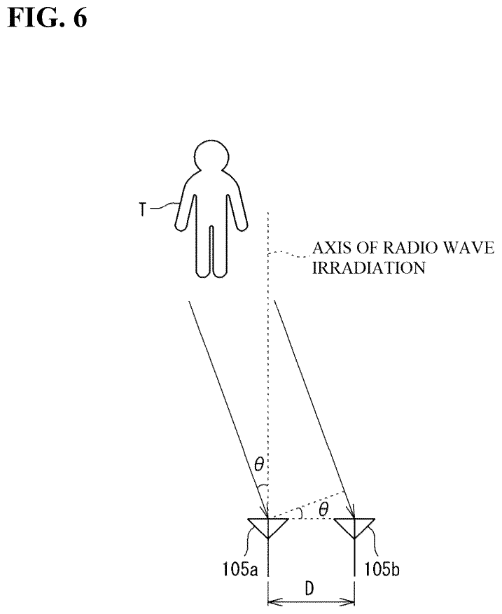

FIG. 7 is a plan view of the radio wave sensor 100 for describing an example of the horizontal angle of a radio wave incident on the reflector 120 and the horizontal angle of a radio wave reflected by the reflector 120. FIG. 7 illustrates a plan view of the radio wave sensor 100 as viewed vertically from above.

A horizontal angle θ1 of a radio wave incident on the reflector 120 and a horizontal angle θ2 of a radio wave reflected by the reflector 120 are determined by the positional relationship (angular relationship) between the reflector 120 and the transmission/reception surface 111. Here, when the horizontal angle θ1 and the horizontal angle θ2 are identical, the azimuth angle detection described above can be used without modification to detect the azimuth angle of the object T based on the radio wave transmitted and received via the reflector 120. In the present embodiment, the positional relationship between the transmission/reception surface 111 and the reflector 120 (reflective surface 121) is determined so that the horizontal angle θ1 and the horizontal angle θ2 become identical.

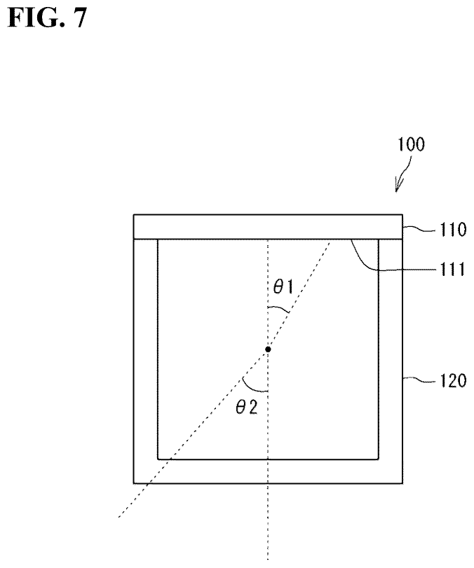

FIG. 8 is a side view of the radio wave sensor 100 for describing an example of the angle of a radio wave incident on the reflector 120 and the angle of a radio wave reflected by the reflector 120. In FIG. 8, vector L, vector R, and vector N are vectors within the vertical plane that intersect the transmission/reception surface 111 perpendicularly. Vector L is a unit vector in the direction of incidence of a radio wave emitted from the transmission/reception surface 111 toward the reflective surface 121. Vector R is a unit vector in the direction of reflection of the radio wave reflected by the reflective surface 121. Vector N is a normal vector of the reflective surface 121. Vector a is a vector in the arrangement direction of the reception antennas 105a, 105b, 105c, and 105d.

The relationship between vector R and vector L is expressed by equation (3) below:

[Eq. 3]

\vec{R}=\vec{L}−2×(\vec{L}·\vec{N})×\vec{N} (3)

Here, if the projection vector of vector R onto vector a and the projection vector of vector L onto vector a are equal, the horizontal angles θ1 and θ2 will be identical.

$$[ Eq . 4 ]$$

$$\begin{matrix}\vec{L} \cdot \vec{a} = \vec{R} \cdot \vec{a} \\ = ( \vec{L} - 2 \times ( \vec{L} \cdot \vec{N} ) \times \vec{N} ) \cdot \vec{a}\end{matrix} \qquad ( 4 )$$

$$2 \times ( \vec{L} \cdot \vec{N} ) \times \vec{N} \cdot \vec{a} = 0$$

From equation (4), the condition for the horizontal angle θ1 and the horizontal angle θ2 to become identical is that the inner product of vector N and vector a is 0. That is, if the normal direction of the reflective surface 121 and the arrangement direction of the reception antennas 105a, 105b, 105c, and 105d for azimuth angle detection are perpendicular to each other, the azimuth angle of the to-be-detected object T can be detected based on a radio wave (indirect reflected wave) received from the to-be-detected object T via the reflector 120 by using the same method (algorithm) as the azimuth angle detection based on a radio wave (direct reflected wave) received by the radio wave sensor 100 directly from the to-be-detected object T. Thus, in the radio wave sensor 100 according to the present embodiment, the reflector 120 is provided at a position and angle at which the normal direction of the reflective surface 121 is perpendicular to the arrangement direction of the reception antennas 105a, 105b, 105c, and 105d used for azimuth angle detection.

Referring back to FIG. 5, the determination unit 132 determines whether the reflected wave received by the reception antennas 105a, 105b, 105c, 105d, and 105e is a direct reflected wave or an indirect reflected wave based on the phase difference of the reflected wave received by the reception antennas 105b and 105e. That is, the determination unit 132 determines whether an object detected based on the reflected wave is an object within the detection area 30A or an object within the detection area 30B based on the phase difference of the reflected wave received by the reception antennas 105b and 105e arranged in the Y direction.

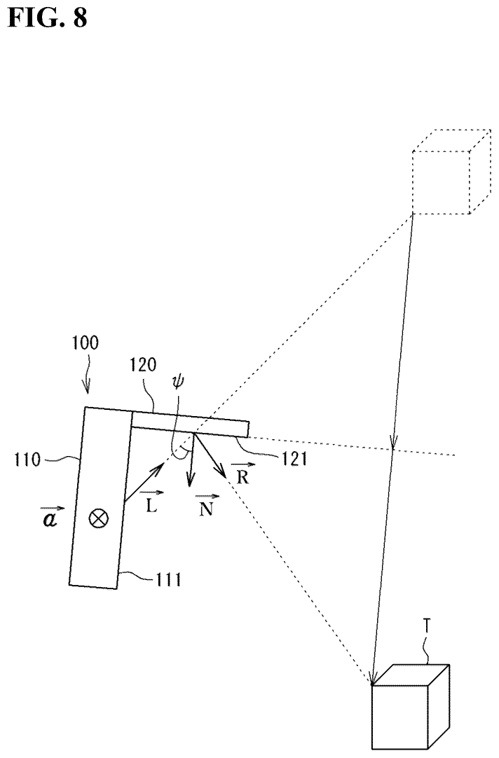

FIG. 9 is a diagram for describing detection of the depression/elevation angle of a reflected wave received via the reflector 120. FIG. 9 illustrates a side view of the radio wave sensor 100 according to the embodiment.

A radio wave transmitted from the transmission/reception surface 111 in a direction with an elevation angle α upward relative to the horizontal plane is assumed. Let ψ be the angle of the reflective surface 121 relative to the horizontal plane, a radio wave is reflected by the reflective surface 121 in a direction of α+2ψ relative to the horizontal plane. The radio wave is reflected by the object T within the detection area 30B, travels back along its original path in the reverse direction, and reaches the transmission/reception surface 111.

Referring back to FIG. 5, the determination unit 132 can detect the direction of arrival of the radio wave, that is, the elevation angle α, based on the phase difference of an indirect reflected wave received by the reception antennas 105b and 105e arranged in the Y direction.

In contrast, a radio wave transmitted downward from the transmission/reception surface 111 is reflected by an object within the detection area 30A, travels back along its original path in the reverse direction, and reaches the transmission/reception surface 111. The determination unit 132 can detect the direction of arrival of the radio wave, that is, the depression angle, based on the phase difference of a direct reflected wave received by the reception antennas 105b and 105e arranged in the Y direction.

The sign of the elevation angle detected when the radio wave arrives from the reflective surface 121 is opposite to the sign of the depression angle detected when the radio wave arrive directly from the object. The determination unit 132 can determine whether the detected object is an object within the detection area 30A or an object within the detection area 30B based on the sign of the detected depression/elevation angle.

For example, the object detection unit 131 may detect the angle of arrival (depression/elevation angle) of the received reflected wave based on the phase difference of the reflected wave received by the reception antennas 105b and 105e, as mentioned earlier.

Furthermore, the object detection unit 131 can detect the vertical angle (depression angle) at which the object is present, based on the angle of arrival of the radio wave (indirect reflected wave) reflected by the reflective surface 121.

Referring back to FIG. 9, a radio wave transmitted from the transmission/reception surface 111 in the direction of the elevation angle α is reflected by the reflective surface 121 toward a direction of α+2ψ relative to the horizontal plane, reaching the object T. Here, the distance from the transmission/reception surface 111 to the reflective surface 121 is sufficiently small, compared to the distance from the transmission/reception surface 111 to the object T. Thus, the depression angle of a straight line (indicated by a dashed line in the drawing) from the transmission/reception surface 111 to the object T relative to the horizontal plane can be regarded as α+2ψ. Therefore, when the object detection unit 131 detects the elevation angle α of the reflected wave from above, the object detection unit 131 can determine the depression angle at which the object is present as α+2ψ. Note that the fact that the distance from the transmission/reception surface 111 to the reflective surface 121 is sufficiently small compared to the distance from the transmission/reception surface 111 to the object T means, for example, that the distance between the most distant points of the transmission/reception surface 111 and the reflective surface 121 is less than or equal to the resolution of the radio wave sensor 100.

### [3. Operation of Radio Wave Sensor]

The radio wave sensor 100 can execute an object detection process and a reflected wave determination process described below by activating the analysis program 107 by the processor 101.

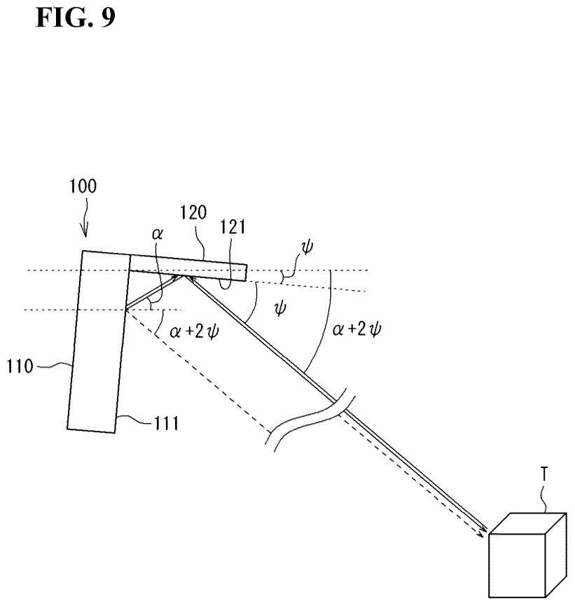

FIG. 10 is a flowchart illustrating an example of the object detection process.

The processor 101 controls the transmission circuit 104 and the reception circuit 105. Accordingly, a modulated wave is transmitted from the transmission antenna 104a, and a reflected wave is received by the reception antennas 105a, 105b, 105c, 105d, and 105e. The processor 101 combines a modulated wave signal output from the transmission circuit 104 with a reflected wave signal of the reception antennas 105a, 105b, 105c, 105d, and 105e output from the reception circuit 105 to generate an IF signal. The processor 101 obtains distance, velocity, azimuth angle, and depression angle information by performing signal processing such as FFT on the IF signal, and generates reflected wave data (step S101).

In step S101, the processor 101 detects the distance, velocity, azimuth angle, and depression angle of an object within the detection area 30A based on a direct reflected wave, and detects the distance, velocity, azimuth angle, and depression angle of an object within the detection area 30B based on an indirect reflected wave. For distance, velocity, and azimuth angle, the processor 101 can detect these without identifying whether the reflected wave is a direct reflected wave or an indirect reflected wave. In contrast, according to the above-mentioned principle, the processor 101 detects the depression angle of the object within the detection area 30A based on the phase difference of the reception wave of the reception antennas 105b and 105e. When the processor 101 detects the elevation angle α of the radio wave received from the reflective surface 121, the processor 101 detects the depression angle of an object within the detection area 30B as α+2ψ.

The processor 101 analyzes the reflected wave data and detects reflection points (peak points) (step S102). The processor 101 groups together the reflection points from the same object (step S103).

The processor 101 saves the detection result, i.e., the object's position (distance, azimuth angle, and depression angle) as well as its velocity in the non-volatile memory 102, and outputs it from the communication I/F 106 (step S104). At this point, the object detection process ends.

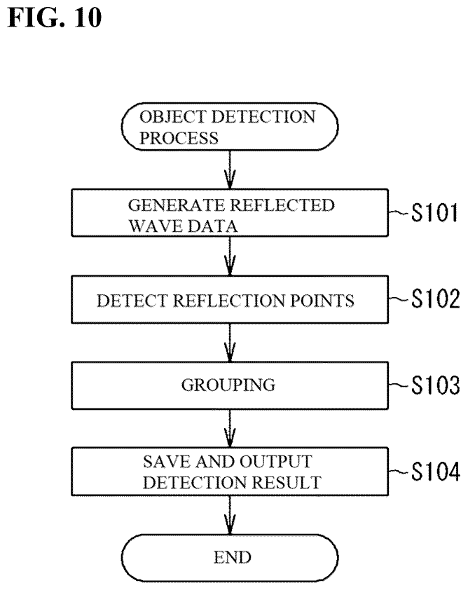

FIG. 11 is a flowchart illustrating an example of the reflected wave determination process.

The processor 101 controls the transmission circuit 104 and the reception circuit 105. Accordingly, a modulated wave is transmitted from the transmission antenna 104a, and a reflected wave is received by the reception antennas 105a, 105b, 105c, 105d, and 105e. The processor 101 combines a modulated wave signal output from the transmission circuit 104 with a reflected wave signal of the reception antennas 105a, 105b, 105c, 105d, and 105e output from the reception circuit 105 to generate an IF signal. The processor 101 obtains distance, velocity, azimuth angle, and depression/elevation angle information by performing signal processing such as FFT on the IF signal, and generates reflected wave data (step S201).

In step S201, the processor 101 detects the distance, velocity, and azimuth angle of an object within the detection area 30A as well as the depression/elevation angle of a radio wave received at the transmission/reception surface 111 based on a direct reflected wave, and detects the distance, velocity, and azimuth angle of an object within the detection area 30B as well as the depression/elevation angle of a radio wave received at the transmission/reception surface 111 based on an indirect reflected wave. In step S201, for distance, velocity, azimuth angle, and depression/elevation angle, the processor 101 can detect these without identifying whether the reflected wave is a direct reflected wave or an indirect reflected wave. That is, when a direct reflected wave from the object is received, the processor 101 detects the depression angle, which is the angle of arrival of the received radio wave, based on the phase difference of the received wave of the reception antennas 105b and 105e. When an indirect reflected wave from the reflective surface 121 is received, the processor 101 detects the elevation angle, which is the angle of arrival of the received radio wave, based on the phase difference of the received wave of the reception antennas 105b and 105e.

The processor 101 analyzes the reflected wave data and detects reflection points (peak points) (step S202). The processor 101 groups together the reflection points from the same object (step S203).

Based on the detected depression/elevation angle, the processor 101 determines whether the received reflected wave is a direct reflected wave from the object or an indirect reflected wave from the reflective surface 121 (step S204).

The processor 101 saves the determination result, i.e., information indicating whether the received reflected wave is a direct reflected wave from the object or an indirect reflected wave from the reflective surface 121, in the non-volatile memory 102, and outputs it from the communication I/F 106 (step S205). Note that, in addition to the above determination result, the detection result of the object's position (distance, azimuth angle, and depression/elevation angle) as well as its velocity may be saved in the non-volatile memory 102, and may be output from the communication I/F 106. At this point, the reflected wave determination process ends.

The above-described reflected wave determination process is executed, for example, during the installation work of the radio wave sensor 100. The worker can adjust the angle of the reflector 120 by referring to the determination result of the reflected wave determination process.

### [4. Modifications]

### [4-1. First Modification]

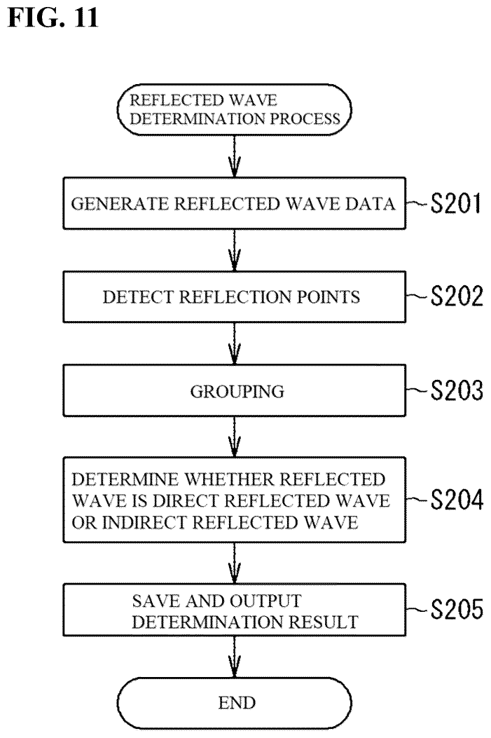

FIG. 12 is a perspective view illustrating a first modification of the configuration of the radio wave sensor according to the embodiment. As illustrated in FIG. 12, a radio wave sensor 100B according to the first modification includes multiple transmission antennas 104a and 104b.

The transmission antennas 104a and 104b are arranged in the Y direction, which is perpendicular to the horizontal direction. The transmission antenna 104a is an example of a first transmission antenna, and the transmission antenna 104b is an example of a second transmission antenna.

In the first modification, the reception antenna 105e is omitted. That is, it is not always necessary to arrange multiple reception antennas in the Y direction.

The determination unit 132 determines whether the reflected wave received by the reception antennas 105a, 105b, 105c, and 105d is a direct reflected wave or an indirect reflected wave based on reception by the reception antennas 105a, 105b, 105c, and 105d of a reflected wave, which is a radio wave transmitted from the transmission antenna 104a and reflected by the object, and reception by the reception antennas 105a, 105b, 105c, and 105d of a reflected wave, which is a radio wave transmitted from the transmission antenna 104b and reflected by the object.

Specifically, in the first modification, the determination unit 132 measures a first period from when a radio wave is transmitted from the transmission antenna 104a to when the radio wave reflected by the object is received by the reception antennas 105a, 105b, 105c, and 105d, and measures a second period from when a radio wave is transmitted from the transmission antenna 104b to when the radio wave reflected by the object is received by the reception antennas 105a, 105b, 105c, and 105d. The determination unit 132 calculates, based on the first period and the second period, the phase difference of the radio wave transmitted from the transmission antenna 104a and received by the reception antennas 105a, 105b, 105c, and 105d and the radio wave transmitted from the transmission antenna 104b and received by the reception antennas 105a, 105b, 105c, and 105d, and detects the depression/elevation angle of the received radio wave based on the calculated phase difference. The determination unit 132 determines whether the reflected wave received by the reception antennas 105a, 105b, 105c, and 105d is a direct reflected wave or an indirect reflected wave based on the detected depression/elevation angle.

The object detection unit 131 may detect the depression angle at a position where the object T is present, based on reception by the reception antennas 105a, 105b, 105c, and 105d of a reflected wave which is a radio wave transmitted from the transmission antenna 104a and reflected by the object, and reception by the reception antennas 105a, 105b, 105c, and 105d of a reflected wave which is a radio wave transmitted from the transmission antenna 104b and reflected by the object.

Specifically, like the above-mentioned determination unit 132, the object detection unit 131 calculates the phase difference of a radio wave transmitted from the transmission antenna 104a and received by the reception antennas 105a, 105b, 105c, and 105d and a radio wave transmitted from the transmission antenna 104b and received by the reception antennas 105a, 105b, 105c, and 105d, and detects the depression/elevation angle of the received radio wave based on the calculated phase difference. In the case where the object detection unit 131 detects the elevation angle α of the radio wave received from the reflective surface 121, the object detection unit 131 can detect the depression angle of the object within the detection area 30B as α+2ψ.

### [4-2. Second Modification]

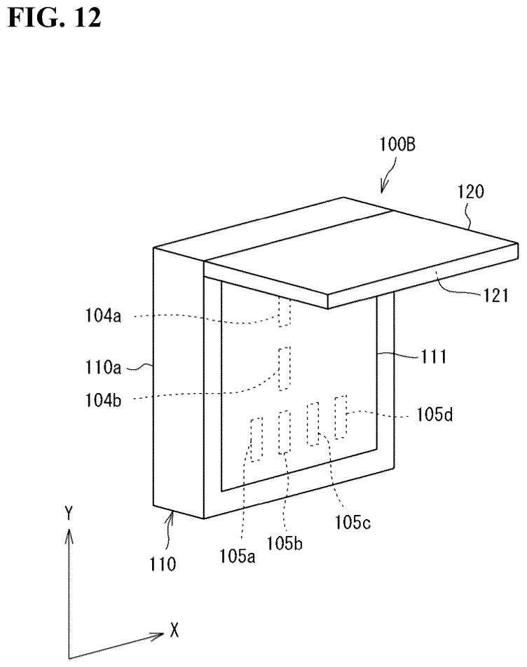

FIG. 13 is a side view illustrating a second modification of the configuration of the radio wave sensor according to the embodiment. As illustrated in FIG. 13, a radio wave sensor 100C according to the second modification includes a first reflector 120A and a second reflector 120B.

The first reflector 120A is attached to the upper edge of the housing 110a of the body 110 on the transmission/reception surface 111 side. The second reflector 120B is attached to the edge opposite the edge of the housing 110a where the first reflector 120A is attached.

The first reflector 120A includes a first reflective surface 121A, which is a mirror surface. The second reflector 120B includes a second reflective surface 121B, which is a mirror surface. The first reflective surface 121A is positioned to reflect a portion of the radio wave transmitted from the transmission/reception surface 111. The second reflective surface 121B is positioned to reflect a portion of the radio wave reflected by the first reflective surface 121A. A certain angle that is not 0° is provided between the first reflective surface 121A and the second reflective surface 121B. That is, the first reflective surface 121A and the second reflective surface 121B are not parallel to each other.

As mentioned above, by providing the first reflective surface 121A and the second reflective surface 121B, which are not parallel to each other, it is possible to further reduce blind spots where no radio wave can reach.

Normal vector N1 of the first reflective surface 121A and vector a in the arrangement direction of the multiple reception antennas 105a, 105b, 105c, and 105d for azimuth angle detection are perpendicular to each other. That is, the normal direction of the first reflective surface 121A and the X direction in which the reception antennas 105a, 105b, 105c, and 105d are arranged are perpendicular to each other.

Normal vector N2 of the second reflective surface 121B and vector a are perpendicular to each other. That is, the normal direction of the second reflective surface 121B and the X direction in which the reception antennas 105a, 105b, 105c, and 105d are arranged are perpendicular to each other.

As described above, by making both normal vector N1 of the first reflective surface 121A and normal vector N2 of the second reflective surface 121B perpendicular to vector a, using the same method (algorithm) as azimuth angle detection based on a radio wave (direct reflected wave) that the radio wave sensor 100 directly receives from the to-be-detected object, the azimuth angle of the to-be-detected object can be detected based on a radio wave reflected by both the first reflective surface 121A and the second reflective surface 121B.

Note that the number of reflective surfaces is not limited to two. It is also acceptable to provide three or more reflective surfaces that are not parallel to one another. Furthermore, the radio wave sensor 100 may be provided with a reflector with a reflective surface curved in a circular arc shape.

### [4-3. Third Modification]

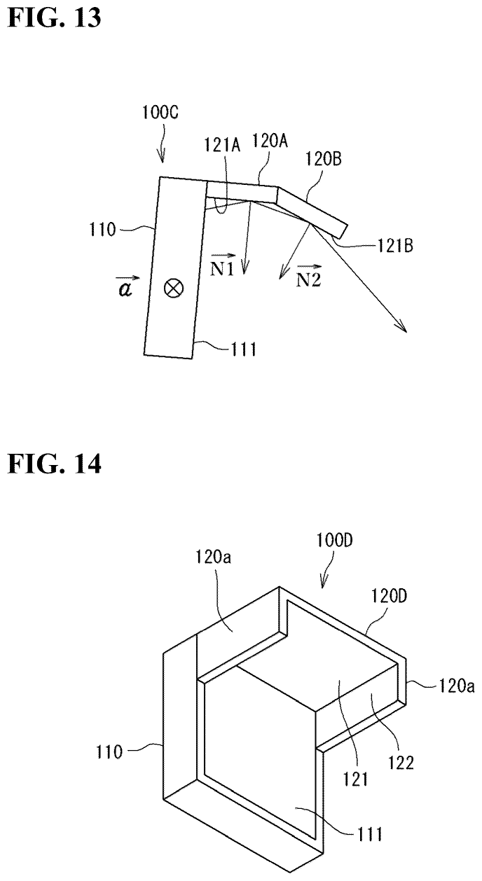

FIG. 14 is a perspective view illustrating a third modification of the configuration of the radio wave sensor according to the embodiment. As illustrated in FIG. 14, a radio wave sensor 100D according to the third modification includes a reflector 120D equipped with side plates 120a on both sides.

The side plates 120a are arranged perpendicular to the reflective surface 121 at both side edges of the reflective surface 121. This makes it possible to suppress the adhesion of raindrops, dust, etc. to the transmission/reception surface 111.

The inner surface of the side plates 120a is a non-reflective surface 122, formed from a material that reflects radio waves poorly, such as a radio-wave absorbing material. This makes it possible to suppress the unwanted reflection of radio waves and to suppress the deterioration of the object detection accuracy.

### [4-4. Other Modifications]

In the embodiment described above, the reflector 120 is attached to the body 110 of the radio wave sensor 100. However, this is not the only possible case. For example, a reflector separate from a radio wave sensor may be installed in the vicinity of the radio wave sensor (e.g., a support member extending from the structure 50).

### [5. Supplement]

The embodiment disclosed herein is exemplary in all respects and is not limiting. The scope of the present invention is defined by the claims rather than the embodiment described above, and includes all modifications within the meaning and scope of the claims and their equivalents.

### REFERENCE SIGNS LIST

10 pedestrian traffic light
20 pedestrian crossing
21A first standby area
21B second standby area
30A detection area (first area)
30B detection area (second area)
40A, 40B radio wave irradiation areas
50 structure
60 road
61A, 61B sidewalks
100, 100A, 100B, 100C, 100D radio wave sensors
101 processor
102 non-volatile memory
103 volatile memory
104 transmission circuit
104a, 104b transmission antennas
105 reception circuit
105a, 105b, 105c, 105d, 105e reception antennas
106 communication interface (communication I/F)
107 analysis program
110 body
110a housing
111 transmission/reception surface
120 reflector
120A first reflector
120B second reflector
120D reflector
120a side plates
121 reflective surface
121A first reflective surface
121B second reflective surface
122 non-reflective surface
131 object detection unit
132 determination unit
T to-be-detected object

1. A radio wave sensor comprising:
at least one transmission antenna configured to transmit a radio wave;
a reception antenna configured to receive a reflected wave, which is radio wave transmitted from the transmission antenna and reflected by an object;
a detection circuitry configured to analyze the reflected wave received by the reception antenna and detect the object; and
a reflector configured to reflect a radio wave,
wherein:
the transmission antenna transmits a first radio wave to a first area;
the reception antenna receives a first reflected wave, which is the first radio wave reflected by a first object within the first area;
the transmission antenna further transmits a second radio wave to the reflector;
the reflector reflects the second radio wave to a second area different from the first area, and the reflector further reflects a second reflected wave, which is the second radio wave reflected by a second object within the second area, to the reception antenna; and
the reception antenna receives the second reflected wave reflected by the reflector.

2. The radio wave sensor according to claim 1, wherein:
a normal direction of a reflective surface of the reflector and an arrangement direction of a plurality of the reception antennas are perpendicular to each other; and
the detection circuitry detects an angle of the second object present within the second area relative to the radio wave sensor based on a phase difference of the second reflected wave received by the plurality of reception antennas.

3. The radio wave sensor according to claim 2, wherein:
the reflective surface includes a first reflective surface and a second reflective surface that are not parallel to each other;
a first normal direction of the first reflective surface and the arrangement direction of the plurality of reception antennas are perpendicular to each other; and
a second normal direction of the second reflective surface and the arrangement direction of the plurality of reception antennas are perpendicular to each other.

4. The radio wave sensor according to claim 1, comprising:
a determination circuitry configured to determine whether a reflected wave received by the plurality of reception antennas is the first reflected wave or the second reflected wave based on a phase difference of the second reflected wave received by the plurality of reception antennas.

5. The radio wave sensor according to claim 4, wherein:
the plurality of reception antennas include a plurality of the reception antennas in a perpendicular direction, which are arranged in a direction perpendicular to a horizontal direction; and
the determination circuitry determines whether a reflected wave received by the reception antennas is the first reflected wave or the second reflected wave based on a phase difference of the second reflected wave received by the plurality of reception antennas in the perpendicular direction.

6. The radio wave sensor according to claim 4, wherein:
the transmission antenna includes a first transmission antenna and a second transmission antenna arranged in a direction perpendicular to a horizontal direction;
the plurality of reception antennas receive a reflected wave which is a radio wave transmitted from the first transmission antenna and reflected by an object, and a reflected wave which is a radio wave transmitted from the second transmission antenna and reflected by the object; and
the determination circuitry determines whether a reflected wave received by the plurality of reception antennas is the first reflected wave or the second reflected wave based on a phase difference of a reflected wave which is a radio wave transmitted from the first transmission antenna and reflected by an object and a reflected wave which is a radio wave transmitted from the second transmission antenna and reflected by the object.

7. An object detection method comprising:
transmitting a first radio wave from at least one transmission antenna to a first area, and transmitting a second radio wave to a reflector;
receiving, by a reception antenna, a first reflected wave, which is the first radio wave reflected by a first object within the first area;
reflecting, by the reflector, the second radio wave to a second area different from the first area, and reflecting, by the reflector, a second reflected wave reflected from a second object within the second area to the reception antenna;
receiving, by the reception antenna, the second reflected wave reflected by the reflector; and
analyzing the first reflected wave and the second reflected wave received by the reception antenna, and detecting the first object and the second object.

8. The radio wave sensor according to claim 2, comprising:
a determination circuitry configured to determine whether a reflected wave received by the plurality of reception antennas is the first reflected wave or the second reflected wave based on a phase difference of the second reflected wave received by the plurality of reception antennas.

9. The radio wave sensor according to claim 3, comprising:
a determination circuitry configured to determine whether a reflected wave received by the plurality of reception antennas is the first reflected wave or the second reflected wave based on a phase difference of the second reflected wave received by the plurality of reception antennas.

10. The radio wave sensor according to claim 8, wherein:
the plurality of reception antennas include a plurality of the reception antennas in a perpendicular direction, which are arranged in a direction perpendicular to a horizontal direction; and
the determination circuitry determines whether a reflected wave received by the reception antennas is the first reflected wave or the second reflected wave based on a phase difference of the second reflected wave received by the plurality of reception antennas in the perpendicular direction.

11. The radio wave sensor according to claim 9, wherein:
the plurality of reception antennas include a plurality of the reception antennas in a perpendicular direction, which are arranged in a direction perpendicular to a horizontal direction; and
the determination circuitry determines whether a reflected wave received by the reception antennas is the first reflected wave or the second reflected wave based on a phase difference of the second reflected wave received by the plurality of reception antennas in the perpendicular direction.

12. The radio wave sensor according to claim 8, wherein:
the transmission antenna includes a first transmission antenna and a second transmission antenna arranged in a direction perpendicular to a horizontal direction;
the plurality of reception antennas receive a reflected wave which is a radio wave transmitted from the first transmission antenna and reflected by an object, and a reflected wave which is a radio wave transmitted from the second transmission antenna and reflected by the object; and
the determination circuitry determines whether a reflected wave received by the plurality of reception antennas is the first reflected wave or the second reflected wave based on a phase difference of a reflected wave which is a radio wave transmitted from the first transmission antenna and reflected by an object and a reflected wave which is a radio wave transmitted from the second transmission antenna and reflected by the object.

13. The radio wave sensor according to claim 9, wherein:
the transmission antenna includes a first transmission antenna and a second transmission antenna arranged in a direction perpendicular to a horizontal direction;
the plurality of reception antennas receive a reflected wave which is a radio wave transmitted from the first transmission antenna and reflected by an object, and a reflected wave which is a radio wave transmitted from the second transmission antenna and reflected by the object; and
the determination circuitry determines whether a reflected wave received by the plurality of reception antennas is the first reflected wave or the second reflected wave based on a phase difference of a reflected wave which is a radio wave transmitted from the first transmission antenna and reflected by an object and a reflected wave which is a radio wave transmitted from the second transmission antenna and reflected by the object.
